(19) United States
(12) Patent Application Publication
(10) Pub. No.: US 2026/0332213 A1
(43) Pub. Date: Oct. 22, 2026

(54) APERIODIC REFERENCE SIGNAL BASED SECONDARY CELL ACTIVATION

(71) Applicant: Nokia Technologies Oy, Espoo (FI)

(72) Inventors: Lei DU, Beijing (CN); Lars DALSGAARD, Oulu (FI)

(21) Appl. No.: 19/114,813

(22) PCT Filed: Sep. 30, 2022
(86) PCT No.: PCT/CN2022/123545

§ 371 Date: Mar. 25, 2025

(51) Int. Cl. H04B 7/06; H04B 17/318; H04L 27/26

(52) U.S. Cl. CPC H04B 7/0626; H04B 17/328; H04L 27/261

(57) ABSTRACT

Embodiments of the present disclosure relate to devices, methods, apparatuses and computer readable storage media of an Aperiodic Reference Signal (ARS) based Secondary Cell (SCell) activation. The method comprises transmitting, from a first device to a second device, a request for triggering a transmission of an aperiodic reference signal based on available beam information upon a secondary cell activation; and receiving the aperiodic reference signal for the secondary cell activation.

### FIELD

Embodiments of the present disclosure generally relate to the field of telecommunication and in particular to devices, methods, apparatuses and computer readable storage media of an Aperiodic Reference Signal (ARS) based Secondary Cell (SCell) activation.

### BACKGROUND

In New Radio (NR), as in Long Term Evolution (LTE), an SCell may be activated or deactivated by network to enable reasonable UE battery consumption when Carrier Aggregation (CA) is configured. When activating a SCell, it takes time i.e., activation delay to transition from deactivated to activated status. In 5th Generation Mobile Communication Technology (5G) New Radio (NR) system, the study on how to reduce the activation delay requirements at both network side and the User Equipment (UE) side is to be further discussed.

### SUMMARY

In general, example embodiments of the present disclosure provide a solution of an ARS based SCell activation.

In a first aspect, there is provide a method. The method comprises transmitting, from a first device to a second device, a request for triggering a transmission of an aperiodic reference signal based on available beam information upon a secondary cell activation; and receiving the aperiodic reference signal for the secondary cell activation.

In a second aspect, there is provide a method. The method comprises receiving, at a second device and from a first device, a request for triggering a transmission of an aperiodic reference signal generated by the first device based on available beam information upon a secondary cell activation; and causing the transmission of the aperiodic reference signal to the first device for the secondary cell activation to be triggered.

In a third aspect, there is provided a first device. The first device comprises at least one processor; and at least one memory storing instructions that, when executed by the at least one processor, cause the first device at least to perform a method according to the first aspect.

In a fourth aspect, there is provided a second device. The second device comprises at least one processor; and at least one memory storing instructions that, when executed by the at least one processor, cause the second device at least to a method according to the second aspect.

In a fifth aspect, there is provided an apparatus comprising means for transmitting, to a second device, a request for triggering a transmission of an aperiodic reference signal based on available beam information upon a secondary cell activation; and means for receiving the aperiodic reference signal for the secondary cell activation.

In a sixth aspect, there is provided an apparatus comprising means for receiving, from a first device, a request for triggering a transmission of an aperiodic reference signal generated by the first device based on available beam information upon a secondary cell activation; and means for causing the transmission of the aperiodic reference signal to the first device for the secondary cell activation to be triggered.

In a seventh aspect, there is provided a computer readable medium having a computer program stored thereon which, when executed by at least one processor of a device, causes the device to carry out the method according to the first aspect or the second aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of an ARS based SCell activation according to some example embodiments of the present disclosure;

FIGS. 3A-3C show examples of UE requested ARS for SCell activation according to some example embodiments of the present disclosure;

FIG. 4 shows a flowchart of an example method of an ARS based SCell activation according to some example embodiments of the present disclosure;

FIG. 5 shows a flowchart of an example method of an ARS based SCell activation according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

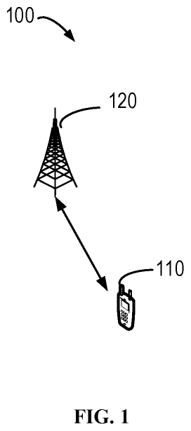

FIG. 1 shows an example communication network 100 in which embodiments of the present disclosure may be implemented. As shown in FIG. 1, the communication network 100 may comprise a terminal device 110. Hereinafter the terminal device 110 may also be referred to as a UE 110 or a first device 110.

The communication network 100 may further comprise a network device 120. Hereinafter the network device 120 may also be referred to as a gNB 120 or a second device 120. The terminal device 110 may communicate with the network device 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, in NR, an SCell may be activated or deactivated by network to enable reasonable UE battery consumption when CA is configured. For example, it can be triggered by a SCell activation/deactivation Medium Access Control-Control Element (MAC CE) to indicate if the SCell with SCellIndex i shall be activated or deactivated.

When activating a SCell, it takes time i.e., activation delay to transition from deactivated to activated status. In some conditions e.g., unknown target SCell, the activation delay may become very long due to cell detection, Layer 1 Reference Signal Received Power (L1-RSRP) measurement and Channel State Information (CSI) measurement etc.

To reduce the delay, a fast SCell activation scheme is proposed to speed up the SCell activation procedure. Aperiodic Channel State Information-Reference Signal (CSI-RS) for tracking, i.e., A-TRS, may be configured for an SCell to assist Automatic Gain Control (AGC) and time/frequency synchronization.

For example, to enable the fast SCell activation when CA is configured, an aperiodic CSI-RS for tracking for fast SCell activation may be configured for an SCell to assist AGC and time/frequency synchronization. A MAC CE is used to trigger activation of one or more SCell(s) and trigger the aperiodic CSI-RS for tracking for fast SCell activation for a (set of) deactivated SCell(s).

Based on the A-TRS, the UE may monitor the A-TRS instead of synchronization signal block (SSB) for cell synchronization. As A-TRS can be configured with very short periodicity, it can occur before SSB hence the SCell activation delay may be reduced.

However, in some scenarios, the A-TRS may be triggered only when the SCell is known, or the SCell is unknown but sharing the same beam information with an active serving cell in the same band, i.e., in contiguous intra-band scenario.

In other words, the A-TRS may be triggered only if the network has the beam information of the SCell to be activated. Hence, it is currently not applied to unknown SCell.

However, the UE is experiencing a much longer activation delay due to beam measurement etc when activating an unknown SCell.

The known/unknown SCell is defined depending on whether the UE has sent a valid measurement report for the SCell within a certain time period, which may not fully reflect the latest UE knowledge of the SCell. For instance, the UE may have performed the intra-frequency measurement of the deactivated SCell when receiving the SCell activation command.

Therefore, a mechanism for triggering an aperiodic reference signal upon a secondary cell activation in both known/unknown SCell scenarios needs to be discussed.

According to some example embodiments of the present disclosure, there is provided a solution for an ARS based SCell activation. In this solution, the UE may send, based on the available beam information, a request for a transmission triggering an aperiodic reference signal (ARS) upon an SCell activation. Upon receiving the request, a transmission of the ARS is triggered at the gNB for the SCell activation. Hereinafter the term “ARS” may also be referred to as an A-TRS or an aperiodic CSI-RS. And the solution can be also applied to activating an primary secondary SCell (PSCell) at secondary cell group (SCG) activation.

Example embodiments of the present disclosure will be described in detail below with reference to the accompanying drawings.

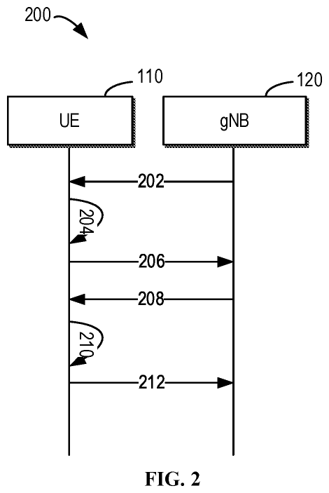

Reference is now made to FIG. 2, which shows a signaling chart 200 for communication according to some example embodiments of the present disclosure. As shown in FIG. 2, the signaling chart 200 involves a UE 110 and a gNB 120. For the purpose of discussion, reference is made to FIG. 1 to describe the signaling chart 200.

As shown in FIG. 2, the gNB 120 may transmit 202 an SCell activation command to the UE 110, to inform the SCell activation procedure is to be initiated from the UE 110.

Then the UE 110 may generate 204 a request for triggering an ARS from the gNB 120. For example, the UE 110 may generate a request for triggering the ARS based on its capability and/or whether available beam information is acquired at the UE 110.

In a case where the UE 110 has a capability of supporting the request for triggering the ARS, the capability may be reported from the UE 110 to the gNB 120. It is to be understood that the UE 110 may report its capability to the gNB 120 before the UE 110 decide to transmit and/or generate the request.

For generating the request, the UE 110 may determine whether one or more SCells potentially to be activated are known. For example, the UE 110 may determine whether these one or more SCells have been detected and/or measurements results of the one or more SCells are acquired. That is, the UE 110 may determine whether the available beam information for the SCell activation is obtained.

In some example embodiments, if the UE 110 has acquired available beam information of the SCell at the time of SCell activation, e.g., by performing intra-frequency measurements on the deactivated SCell being activated, the UE 110 may select the best DL beam and request the ARS to be triggered (transmitted) on the selected DL beam. That is, the UE 110 may generate the request for triggering the ARS indicating the ARS is triggered on the selected DL beam.

It is also possible that the UE 110 does not have available beam information of the SCell at the time of SCell activation, i.e., the SCell(s) are unknown by the UE 110, the UE 110 may perform corresponding measurements on the SCell(s).

The case where the UE 110 does not have available beam information may refer to two different scenarios. In some example embodiments, the SCell(s) have been detected upon the SCell activation but the SSB index has not been acquired. In this situation, the UE 110 may determine at least one preferred beam based on SSB indices. For example, the UE 110 may read the SSB indices, e.g., 8*Trs in the SCell to determine one or more candidate DL beams, as the at least one preferred beam. Then the UE 110 may generate the request indicating the ARS to be triggered on the one or more candidate DL beams, which may be, for example, identified by the one or more SSB indices.

In some other example embodiments, the SCell(s) have not been detected upon the SCell activation. In this case, the UE 110 may perform a cell detection before requesting the ARS.

In some other example embodiments, one or more information may be included in the request to assist the ARS triggering. For example, the request may include the candidate/preferred beam(s) where the ARSs are expected to be transmitted, which may be indicated by different indices or identifications (IDs). As an option, the candidate/preferred beam(s) may be indicated by SSB index the UE has acquired. As another option, the candidate/preferred beam(s) may be indicated by CSI-RS IDs, e.g., the scellActivationRS-Id or the Non-Zero Power (NZP) CSI-RS-ResourceSetId which has been configured on the to-be-activated SCell. Furthermore, the UE 110 may also prioritize the beams where the ARS resources or A-TRS are configured for the fast SCell activation.

Alternatively or optionally, the request may include the configuration of the one or more aperiodic reference signals, and/or the number of ARS bursts expected on the candidate/preferred beam(s). The number of bursts may be dependent on the latest measurement or cell status at the UE 110. For instance, If the cell has been detected at the time of the SCell activation, the UE 110 may request single ARS for SCell activation. Otherwise if the cell has not been detected, the UE may request two or more ARS bursts for SCell activation.

Alternatively or optionally, the request may include the usage of the ARS burst for SCell activation. It indicates if the requested ARS burst(s) are used for which of the activation steps following SCell activation command, including AGC, time and frequency tracking, L1-RSRP measurement, fine time tracking and channel measurement. As an example, 3-digit “usage” may be used to indicate if the ARS burst is used for cell detection including AGC and time and frequency (T/F) tracking, L1-RSRP measurement and/or CSI-RS measurement respectively.

Alternatively or optionally, the request may also include the configuration of the one or more ARSs.

For example, if the SCell is in deactivated state and the request is received, network will activate/trigger the ARS on the beam corresponding to the received SSB or that is QCL-ed to the received SSB.

Referring back to FIG. 2, the UE 110 may transmit 206 the request for triggering the ARS to the gNB 120. In some example embodiments, the request is transmitted from the UE 110 after the UE 110 receives the SCell activation command from the gNB 120 or transmits a HARQ ACK in response to the activation command. A predetermined period is defined within which the UE shall be able to transmit the request after the UE 110 receives the SCell activation command from the gNB 120 or transmits a HARQ ACK in response to the activation command. If the UE fails to transmit the request within the predetermined period, the SCell is assumed to be activated following legacy unknown SCell activation procedure. For example, the predetermined period, which may be represented as “T_{ARS_req}” may be equal to a period for reporting L1 RSRP measurement, i.e., “T_{LI-RSRP,reporting}”, if the CSI reporting resources on PCell or any active serving cell is used to send the request. For example, a threshold time period “T_{ARS_req_ threshold}” may be set for transmitting the request.

In some example embodiments, the request is transmitted from the UE 110 to the gNB 120 via a MAC CE, or a RRC message or by reusing CSI reporting resources in a primary cell or an active serving cell.

After receiving the request, the gNB 120 may trigger the transmission of the ARS. As shown in FIG. 2, the ARS may be transmitted 208 from the gNB 120 to the UE 110. Alternatively or optionally, the ARS may also be transmitted from other gNBs (not shown) to the UE 110. For example, the transmission of the ARS may be triggered based on one or more information indicated in the request.

For example, if at least one candidate/preferred beam is indicated in the request, the gNB 120 may trigger the ARS transmission on the indicated at least one candidate/preferred beam for the SCell activation procedure. If the at least one candidate/preferred beam is indicated by the SSB index, the gNB 120 may activate/trigger the ARS on the beam corresponding to the received SSB index or that is Quasi-Colocation (QCL)-ed to the received SSB.

As another option, if the usage of the ARS burst for SCell activation is indicated in the request, the gNB 120 may trigger the ARS transmission based on the usage of the ARS burst.

Furthermore, the gNB 120 may also transmit an indication of a Transmission Configuration Indicator (TCI) state to the UE 110. The UE 110 may monitor the DL ARS transmission based on the TCI state.

Based on the received ARS, the UE 110 may perform 210 a cell synchronization (e.g., AGC and time/frequency synchronization) based on the ARS. After the UE 110 completes the cell synchronization based on the ARS, the UE 110 may measure a semi periodic (SP)-CSI-RS or periodic CSI-RS and send 212 a CSI report for the SCell.

As an option, the SP-CSI-RS may be activated in the same MAC CE of ARS/TCI activation to avoid additional MAC uncertainty time. As another option, if the UE 110 indicates the usage of ARS is also for CSI measurement, the UE 110 may also skip SP-CSI-RS measurement and send a CSI report based on ARS.

Although the case where the transmission of the ARS is triggered based on the UE request has been described, it is to be understood that the gNB 120 may transmit the ARS on one or more beams, which may be applied, with and without the UE request, for a case where the SCell is known and a case where the SCell is unknown. As an example, the ARS may be transmitted by the gNB 120 based on the last measurement report from the UE 110. Hence, in a case where the UE may assume that the gNB transmits ARS on the last used associated DL SSB and the SSB quality is still good (and e.g., without time limit), the UE 110 may activate the SCell activation based on ARS instead of SSB.

With the solution of the present disclosure, the UE may benefit from the available beam information and ARS to speed up the activation for an unknown SCell. With the available DL beam information, the UE may treat the former unknown SCell as known and request the assistance ARS for AGC and time/frequency tracking, and/or the other activation steps on the best beam. This may enable the network to transmit to the UE the ARS on the reported DL beam which may reduce the UE SCell activation time.

Meanwhile, the additional beam (i.e., L1-RSRP) measurement procedure for activating an unknown SCell may be saved. The ARS may help UE to perform frequency and time tracking on the SCell in a shorter time period i.e., the period of the CSI-RS burst, which may further reduce the activation delay by SSB-based time/frequency tracking.

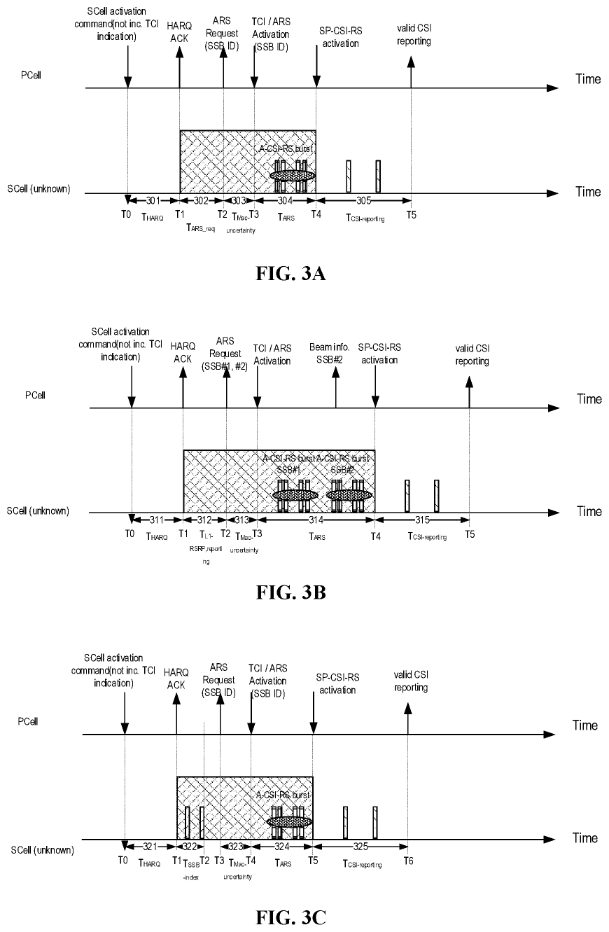

Now some examples for triggering the ARS transmission upon the SCell activation may be further described in detail with reference to FIGS. 3A-3C.

As shown in FIG. 3A, at the beginning of the timeline (i.e., at T0), the UE 110 receives an SCell activation command to activate an unknown SCell. For example, there is no active serving cell or known SCell on the band. As the SCell is unknown, the gNB 120 has not received valid L3 measurement reporting within a time period hence does not know the latest DL beam information where the UE 110, e.g., can be scheduled and is therefore not able to send the TCI indication.

In the example shown in FIG. 3A, the intra-frequency or serving cell measurement on the SCell being activated has been performed by the UE 110 and hence the UE 110 may determine the DL beam information related to e.g., SSB index #1 at the time of SCell activation. Then the UE 110 sends an ARS request within a time period T_{ARS_req}. (i.e., the time period 302 between T1 and T2). The ARS request may be transmitted in a MAC message, a RRC message or a reusing CSI reporting resources in PCell or any other serving cell.

As an option, T_{ARS_req} may also be TL1-RSRP, reporting if the CSI reporting resources on PCell is used to send the request. The UE 110 may be able to initiate the request within a time period threshold i.e., T_{ARS_req_threshold}.

For example, the request may be transmitted from the UE 110 at T2. The request may include at least the beam information where ARS is expected, e.g., SSB ID#1. It may also include the ARS index if the ARSs have been configured for the SCell before the SCell activation and the number of bursts expected for the ARS.

Upon receiving the ARS request, the gNB 120 may trigger (at T3) the ARS on the indicated DL beam corresponding to SSB ID 190 1, or the indicated ARS (if ARS index is indicated). The TCI indication can be sent in the same MAC CE to indicate the DL beams to be monitored by the UE 110. The time period between the T2 and T3 may be referred to as T_{MAC-uncertainty}.

Then the UE 110 may receive the ARS burst(s) during the period 304 between T3 and T4. After the UE completes cell synchronization (e.g., AGC and time/frequency synchronization) based on the ARS, the UE may measure the SP-CSI-RS or periodic CSI-RS during the time period 305 between T4 and T5 and send (at T5) CSI reporting for the SCell.

As an option, the SP-CSI-RS may be activated in the same MAC CE of ARS/TCI activation to avoid additional MAC uncertainty time. In another option, if the UE 110 indicates the usage of ARS is also for CSI measurement, the UE 110 may skip the SP-CSI-RS measurement and send CSI reporting based on ARS.

In some example embodiments, the UE 110 may send the CSI reporting based on the measurement on the ARS burst (not shown). The network may start scheduling the UE after receiving the CSI reporting.

In the example shown in FIG. 3B, similarly with FIG. 3A, the UE 110 receives an SCell activation command to activate an unknown SCell at the beginning of the timeline (i.e., at T0). The UE 110 sends an ARS request within a time period T_{ARS_req}. (i.e., the time period 312 between T1 and T2). The ARS request may be transmitted in a MAC message, a RRC message or a reusing CSI reporting resources in PCell or SCell. For example, T_{ARS_req} may also be T_{L1-RSRP,reporting} if the CSI reporting resources on PCell is used to send the request. Then the request may be transmitted from the UE 110 at T2.

In this case, the UE may request the ARS transmission on more than one candidate beams e.g., based on its implementation information e.g., Rx beam setting or panel information. As in FIG. 3B, the UE 110 may request the ARS on beams corresponding to SSB#1 and #2. In one option, the UE 110 may indicate if the same ARS is transmitted on more than one beam or each ARS is transmitted on single beam. The gNB 120 may activate ARS on the two beams for the cell synchronization.

Alternatively or optionally, the gNB 120 may also send ARS on multiple beams without UE requests. The gNB 120 may transmit ARS on multiple beams based on the latest received measurement reporting from the UE.

Different from the example in FIG. 3A, the UE needs to indicate the beam on which the cell synchronization has been completed based on ARS. The gNB 120 is able to indicate (at T3) the TCI indication as well as activate the SP-CSI-RS for channel measurements afterwards. In the example of FIG. 3B, the ARS burst is transmitted on multiple beams which extends the time period (time period 314) for cell synchronization comparing with that (time period 304 in FIG. 3A) for single ARS. However, it still saves the activation time by avoiding beam sweeping time i.e., 8*Trs for Frequency Range (FR2) unknown SCell.

After the UE completes cell synchronization (e.g., time/frequency synchronization) based on the ARS, the UE may measure the SP-CSI-RS or periodic CSI-RS during the time period 315 between T4 and T5 and send (at T5) CSI reporting for the SCell.

In the example shown in FIG. 3C, similarly with FIGS. 3A and 3B, the UE 110 receives an SCell activation command to activate an unknown SCell at the beginning of the timeline (i.e., at T0). In this case, the UE may have detected the cell but does not have the exact beam information of the SCell e.g., not having the valid L3 measurement of the SCell. In this case, as in FIG. 3C, the UE need read (during the period 322) the SSB index to acquire the beam information (i.e., SSB index) before sending the ARS request to the network. Then the time period 322, which may be called as additional time Tssb-index, is needed for SSB index reading on the SCell. Other actions or processes which are similar or same as that of FIGS. 3A and 3B will be omitted here.

In another example, the UE may have not detected the cell at the time of SCell activation (not shown). In this case, the UE may need do SSB-based cell detection and acquire the SSB index before it can initiate the ARS request. The activation delay may not be quite different from a current SCell activation process.

In some example embodiments, the activation time for the ARS transmission, i.e., Tactivation_time may be defined based on the proposed activation steps above. For example, if the UE supports UE requested ARS capability, T_{activation_time} may be equal to T_{L1-RSRP}, reporting+T_{FirstATRS}+T_{MAC-uncertaint}y+5 ms, wherein T TFirstATRS is the time to the end of the first complete ARS burst for SCell activation after slot

$$n + \frac{{T}_{HARQ} + 3 ms}{NR slot length} .$$

In one example, the ARS burst is defined as four CSI-RS resources in two consecutive slots as an example.

In this way, a mechanism for tiggering the ARS may be achieved, to assist the UE to perform AGC and frequency and time tracking, and/or other activation steps on the SCell in a shorter time period.

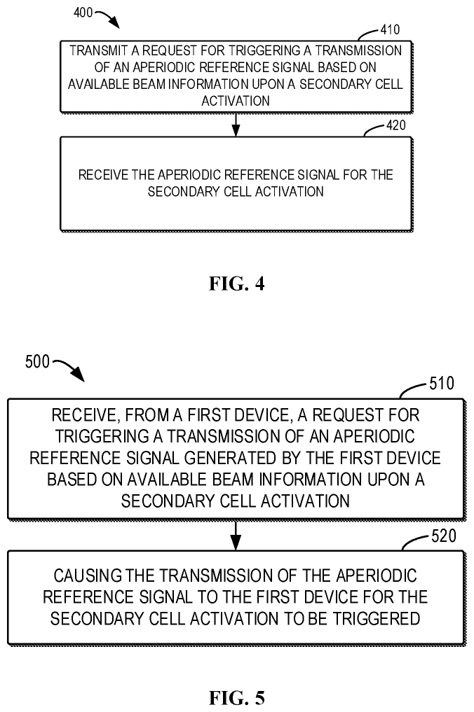

FIG. 4 shows a flowchart of an example method 400 of an ARS based SCell activation according to some example embodiments of the present disclosure. The method 400 may be implemented at the first device 110 as shown in FIG. 1. For the purpose of discussion, the method 400 will be described with reference to FIG. 1.

At 410, the first device 110 transmit, to a second device, a request for triggering a transmission of an aperiodic reference signal based on available beam information upon a secondary cell activation.

In some example embodiments, the first device may report, to the second device, a capability of supporting the request at the first device.

In some example embodiments, the request is transmitted in at least one of a MAC message, a RRC message, or by reusing channel state information reporting resources in a primary cell or an active serving cell.

In some example embodiments, if the first device receives a command for the secondary cell activation from the second device, the first device may transmit the request within a predetermined time period.

In some example embodiments, the predetermined time period is a time period for reporting a reference signal received power of layer 1 if channel state information reporting resources on a primary cell or an active serving cell is used to transmit the request.

In some example embodiments, if a beam information is available, the first device may transmit the request at least indicating the aperiodic reference signal to be triggered on a beam.

In some example embodiments, if a beam information is not available and the secondary cell to be activated has been detected, the first device may determine at least one preferred beam based on synchronization signal block indices and transmit the request at least indicating the aperiodic reference signal to be triggered on the at least one preferred beam.

In some example embodiments, if a beam information is not available and the secondary cell to be activated has not been detected, the first device may perform a cell detection for the secondary cell activation.

In some example embodiments, the request comprises at least one of at least one preferred beam on which one or more aperiodic reference signals are expected to be transmitted, the number of bursts for the one or more aperiodic reference signals expected on the at least one preferred beam, the configuration of the one or more aperiodic reference signals, or a usage of the burst for the secondary cell activation.

In some example embodiments, the at least one preferred beam is indicated by at least one of at least one synchronization signal block index that the first device has acquired, or respective aperiodic channel state information reference signal index associated with the at least one preferred beam, where the aperiodic channel state information reference signal is configured before the secondary cell activation.

At 420, the first device receives the aperiodic reference signal for the secondary cell activation.

In some example embodiments, the first device may receive, from the second device, an indication of transmission configuration indicator state associated with the transmission and monitor the aperiodic reference signal at least based on the indication.

In some example embodiments, the first device may receive, an activation of a semi-periodic channel state information reference signal or a configuration of a periodic channel state information reference signal along with an indication of transmission configuration indicator state or the aperiodic reference signal.

In some example embodiments, the first device may generate a channel state information report based on a measurement on at least of the aperiodic reference signal, a semi-periodic channel state information reference signal, or a periodic channel state information reference signal; and transmit the channel state information report.

In some example embodiments, the first device may comprise a terminal device and the second device may comprise a network device.

FIG. 5 shows a flowchart of an example method 500 of an ARS based SCell activation according to some example embodiments of the present disclosure. The method 500 may be implemented at the second device 120 as shown in FIG. 1. For the purpose of discussion, the method 500 will be described with reference to FIG. 1.

At 510, the second device receives, from the first device, a request for triggering a transmission of an aperiodic reference signal generated by the first device based on available beam information upon a secondary cell activation.

At 520, the second device causes the transmission of the aperiodic reference signal to the first device for the secondary cell activation to be triggered.

In some example embodiments, the second device may receive, from the first device, a capability of supporting the request at the first device.

In some example embodiments, the request is transmitted in at least one of a MAC message, a RRC message, or by reusing channel state information reporting resources in a primary cell or an active serving cell.

In some example embodiments, the request comprises at least one of at least one preferred beam on which one or more aperiodic reference signals are expected to be transmitted, the number of bursts for the one or more aperiodic reference signals expected on the at least one preferred beam, the configuration of the one or more aperiodic reference signals, or a usage of the burst for the secondary cell activation.

In some example embodiments, the at least one preferred beam is indicated by at least one of at least one synchronization signal block index that the first device has acquired, or respective aperiodic channel state information reference signal index associated with the at least one preferred beam, where the aperiodic channel state information reference signal is configured before the secondary cell activation.

In some example embodiments, the second device may transmit, to the first device, an indication of transmission configuration indicator state associated with the transmission.

In some example embodiments, the second device may transmit, to the first device, an activation of a semi-periodic channel state information reference signal or a configuration of a periodic channel state information reference signal along with an indication of transmission configuration indicator state or the aperiodic reference signal.

In some example embodiments, the second device may receive, from the first device, a channel state information report generated by the first device based on at least of the aperiodic reference signal, a semi-periodic channel state information reference signal, or a periodic channel state information reference signal.

In some example embodiments, the first device comprises a terminal device and the second device comprises a network device.

In some example embodiments, an apparatus capable of performing the method 400 (for example, implemented at the first device 110) may include means for performing the respective steps of the method 400. The means may be implemented in any suitable form. For example, the means may be implemented in a circuitry or software module.

In some example embodiments, the apparatus comprises means for transmitting, to a second device, a request for triggering a transmission of an aperiodic reference signal based on available beam information upon a secondary cell activation; and means for receiving the aperiodic reference signal for the secondary cell activation.

In some example embodiments, an apparatus capable of performing the method 500 (for example, implemented at the second device 120) may include means for performing the respective steps of the method 500. The means may be implemented in any suitable form. For example, the means may be implemented in a circuitry or software module.

In some example embodiments, the apparatus comprises means for receiving, from a first device, a request for triggering a transmission of an aperiodic reference signal generated by the first device based on available beam information upon a secondary cell activation; and means for causing the transmission of the aperiodic reference signal to the first device for the secondary cell activation to be triggered.

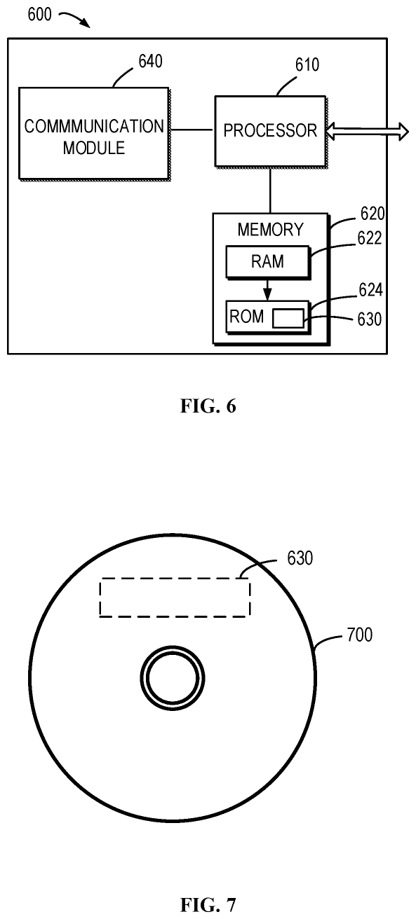

FIG. 6 is a simplified block diagram of a device 600 that is suitable for implementing example embodiments of the present disclosure. The device 600 may be provided to implement a communication device, for example, the terminal device 110 or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-26. (canceled)

27. A first device comprising:
at least one processor; and
at least one memory storing instructions that, when executed by the at least one processor, cause the first device at least to perform the following:
determining that a beam information is not available;
determining that a secondary cell to be activated has been detected;
in accordance with a determination that the beam information is not available and the secondary cell to be activated has been detected, determining at least one preferred beam based on synchronization signal block indices that the first device has acquired and respective aperiodic channel state information reference signal index associated with the at least one preferred beam, where the aperiodic channel state information reference signal is configured before the secondary cell activation;
transmitting, to a second device, a request for triggering a transmission of an aperiodic reference signal based on available beam information upon the secondary cell activation, the request at least indicating the aperiodic reference signal to be triggered on the at least one preferred beam, wherein the request is transmitted in the following: a medium access control message, a radio resource control message, and by reusing channel state information reporting resources in a primary cell or an active serving cell, and wherein the request comprises the following: a number of bursts for the one or more aperiodic reference signals expected on the at least one preferred beam, the configuration of the one or more aperiodic reference signals, and a usage of the burst for the secondary cell activation;
receiving the aperiodic reference signal for the secondary cell activation;
generating a channel state information report based on a measurement on the following: the aperiodic reference signal, a semi-periodic channel state information reference signal, and a periodic channel state information reference signal; and
transmitting the channel state information report.

28. The first device of claim 27, wherein the first device is further cause to perform the following:
report, to the second device, a capability of supporting the request at the first device.

29. The first device of claim 28, wherein transmitting the request comprises:
in accordance with a determination that a command for the secondary cell activation is received from the second device, transmitting the request within a predetermined time period.

30. The first device of claim 29, wherein the predetermined time period is a time period for reporting a reference signal received power of layer 1 if channel state information reporting resources on a primary cell or an active serving cell is used to transmit the request.

31. The first device of claim 30, wherein the first device is further caused to perform the following:
receiving, from the second device, an indication of transmission configuration indicator state associated with the transmission of the aperiodic reference signal; and
monitoring the aperiodic reference signal at least based on the indication.

32. The first device of claim 31, wherein the first device is further caused to perform the following:
receiving an activation of a semi-periodic channel state information reference signal or a configuration of a periodic channel state information reference signal along with an indication of transmission configuration indicator state or the aperiodic reference signal.

33. The first device of claim 32, wherein the first device comprises a terminal device and the second device comprises a network device.

34. A system comprising:
a first device;
at least one processor; and
at least one memory storing instructions that, when executed by the at least one processor, cause the first device at least to perform the following:
determining that a beam information is not available;
determining that a secondary cell to be activated has been detected;
in accordance with a determination that the beam information is not available and the secondary cell to be activated has been detected, determining at least one preferred beam based on synchronization signal block indices that the first device has acquired and respective aperiodic channel state information reference signal index associated with the at least one preferred beam, where the aperiodic channel state information reference signal is configured before the secondary cell activation;
transmitting, to a second device, a request for triggering a transmission of an aperiodic reference signal based on available beam information upon the secondary cell activation, the request at least indicating the aperiodic reference signal to be triggered on the at least one preferred beam, wherein the request is transmitted in the following: a medium access control message, a radio resource control message, and by reusing channel state information reporting resources in a primary cell or an active serving cell, and wherein the request comprises the following: a number of bursts for the one or more aperiodic reference signals expected on the at least one preferred beam, the configuration of the one or more aperiodic reference signals, and a usage of the burst for the secondary cell activation;
receiving the aperiodic reference signal for the secondary cell activation;
generating a channel state information report based on a measurement on the following: the aperiodic reference signal, a semi-periodic channel state information reference signal, and a periodic channel state information reference signal; and
transmitting the channel state information report.

35. The system of claim 34, wherein the first device is further cause to perform the following:
report, to the second device, a capability of supporting the request at the first device.

36. The system of claim 35, wherein transmitting the request comprises:
in accordance with a determination that a command for the secondary cell activation is received from the second device, transmitting the request within a predetermined time period.

37. The system of claim 36, wherein the predetermined time period is a time period for reporting a reference signal received power of layer 1 if channel state information reporting resources on a primary cell or an active serving cell is used to transmit the request.

38. The system of claim 37, wherein the first device is further caused to perform the following:
receiving, from the second device, an indication of transmission configuration indicator state associated with the transmission of the aperiodic reference signal; and
monitoring the aperiodic reference signal at least based on the indication.

39. The system of claim 38, wherein the first device is further caused to perform the following:
receiving an activation of a semi-periodic channel state information reference signal or a configuration of a periodic channel state information reference signal along with an indication of transmission configuration indicator state or the aperiodic reference signal.

40. The system of claim 39, wherein the first device comprises a terminal device and the second device comprises a network device.

41. A method comprising:
determining, by a first device, that a beam information is not available;
determining, by the first device, that a secondary cell to be activated has been detected;
in accordance with a determination that the beam information is not available and the secondary cell to be activated has been detected, determining, by the first device, at least one preferred beam based on synchronization signal block indices that the first device has acquired and respective aperiodic channel state information reference signal index associated with the at least one preferred beam, where the aperiodic channel state information reference signal is configured before the secondary cell activation;
transmitting, to a second device, a request for triggering a transmission of an aperiodic reference signal based on available beam information upon the secondary cell activation, the request at least indicating the aperiodic reference signal to be triggered on the at least one preferred beam, wherein the request is transmitted in the following: a medium access control message, a radio resource control message, and by reusing channel state information reporting resources in a primary cell or an active serving cell, and wherein the request comprises the following: a number of bursts for the one or more aperiodic reference signals expected on the at least one preferred beam, the configuration of the one or more aperiodic reference signals, and a usage of the burst for the secondary cell activation;
receiving, by the first device, the aperiodic reference signal for the secondary cell activation;
generating, by the first device, a channel state information report based on a measurement on the following: the aperiodic reference signal, a semi-periodic channel state information reference signal, and a periodic channel state information reference signal; and
transmitting, by the first device, the channel state information report.

42. The method of claim 41, further comprising:
reporting, to the second device, a capability of supporting the request at the first device.

43. The method of claim 42, wherein transmitting the request comprises:
in accordance with a determination that a command for the secondary cell activation is received from the second device, transmitting the request within a predetermined time period.

44. The method of claim 43, wherein the predetermined time period is a time period for reporting a reference signal received power of layer 1 if channel state information reporting resources on a primary cell or an active serving cell is used to transmit the request.

45. The method of claim 44, further comprising:
receiving, from the second device, an indication of transmission configuration indicator state associated with the transmission of the aperiodic reference signal; and
monitoring the aperiodic reference signal at least based on the indication.

46. The method of claim 45, further comprising:
receiving an activation of a semi-periodic channel state information reference signal or a configuration of a periodic channel state information reference signal along with an indication of transmission configuration indicator state or the aperiodic reference signal.
